(19) United States
(12) Patent Application Publication
(10) Pub. No.: US 2023/0109353 A1
(43) Pub. Date: Apr. 6, 2023

(54) FLUORINE-CONTAINING COPOLYMER COMPOSITION

(71) Applicant: KANTO DENKA KOGYO CO., LTD., Tokyo (JP)

(72) Inventors: Yoshitaka MATSUDA, Shibukawa, Shibukawa-shi, Gunma (JP); Katsuya FUKAE, Shibukawa, Shibukawa-shi, Gunma (JP)

(21) Appl. No.: 17/904,520

(22) PCT Filed: Feb. 24, 2021
(86) PCT No.: PCT/JP2021/006774

§ 371 Date: Aug. 18, 2022

(30) Foreign Application Priority Data
Feb. 25, 2020 (JP) 2020-029783

(51) Int. Cl. C08F 214/22; C08F 214/26; C09D 127/16; C09D 127/18

(52) U.S. Cl. CPC C08F 214/225; C08F 214/265; C09D 127/16; C09D 127/18

(57) ABSTRACT

An object is to provide a fluorine-containing copolymer composition that exhibits long-term stability as well as a fluororesin paint or varnish prepared using the composition.

Provided are: a composition comprising a fluorine-containing copolymer synthesized through copolymerization of 0.001 to 50 mol % of particular ethylenically unsaturated organosilicon compound polymerization units relative to 5 to 85 mol % of fluoroolefin polymerization units by a solution polymerization method, a solvent, and an amine compound; a fluororesin paint or varnish prepared using the composition; and a method of producing the fluorine-containing copolymer composition.

### TECHNICAL FIELD

The present invention relates to a fluorine-containing copolymer that is excellent in water and oil repellency, in the characteristics of fluororesin, such as chemical resistance and weatherability, and in compatibility with acrylic resins and to a fluororesin paint or varnish based thereon.

### BACKGROUND ART

A solvent-soluble fluororesin paint is typically obtained by copolymerizing a hydroxyalkyl vinyl ether, a fluoroolefin, and as necessary, an alkyl vinyl ether, an alkyl vinyl ester, and so forth. To attain solubility in common organic solvents, a paint based on such a fluorine-containing copolymer contains 40% or more of a hydrocarbon monomer. For this reason, the fluorine content of the fluororesin is low. Consequently, it is impossible to satisfactorily attain coating film characteristics required for fluororesin, such as water and oil repellency and soiling resistance. Meanwhile, water and oil repellency improves by mixing a small amount of organosilicon compound, such as silicone oil, with the fluorine-containing copolymer. However, it is difficult to maintain water- and oil-repellent characteristics for a long period of time. Moreover, silicone oil cannot be used for some purposes due to bleeding out thereof from the coating film surface. Meanwhile, a copolymer of a silyl group-containing monomer and a fluorine-containing monomer having a perfluoro group has been investigated as a water and oil repellent agent. However, since the copolymer does not have fluorine atoms on the main backbone, satisfactory weatherability has not been attained.

The applicant provided a solvent-soluble fluororesin paint or varnish that had resolved the above-mentioned problems (Patent Literature (PTL) 1). However, there remained a need for further improvement in stability. Specifically, in the industry concerned, there was a need for long-term (three months or more) storage after production. Upon exposure to light, a solution of a fluorine-containing copolymer tends to gradually undergo gelation. For this reason, when a fluororesin paint or varnish is left to stand in a container, the viscosity tends to increase around after six months or more.

### CITATION LIST

### Patent Literature

PTL 1: Japanese Patent No. 4298117

### SUMMARY OF INVENTION

### Technical Problem

An object of the present invention is to provide a fluorine-containing copolymer composition that exhibits long-term stability as well as a fluororesin paint or varnish prepared using the composition.

### Solution to Problem

The present invention provides tee following.

[1] A composition comprising:

a fluorine-containing copolymer formed from polymerization units containing 5 to 85 mol % of a fluoroolefin and 0.001 to 50 mol % of one or more organosilicon compounds selected from general formulae (1), (2), (3), (4), (5), and (6);

a solvent; and

an amine compound.

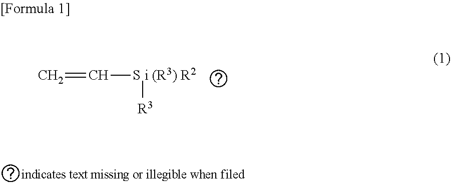

where: R¹, R², and R³ are each independently a hydrogen atom, a methyl group, an ethyl group, a butyl group, a phenyl group, —CF₃, —C₂H₄CF₃, —C(CH₃)₃, or —OSi(CH₃)₃; and R¹, R², and R³ may be the same or different from each other.

[Formula 2]

CH₂═CR⁴—R³—(CH₂)—Si(CH₂)₂—(O—Si(CH₂)—OSi(CH₂)₂R⁶ (2)

$$[ Formula 3 ]$$

$$\text{?} = {C R}^{4} - COO - ( {CH}_{2} ) \text{?} - S \text{?} ( C \text{?} ) \text{?} -- [ O - S i ( C \text{?} ) \text{?} ) \text{?} - O S i ( C \text{?} ) \text{?} \qquad ( 3 )$$

$$\text{?} \text{indicates text missing or illegible when filed}$$

where: R⁴ is a hydrogen atom or a methyl group; R⁵ is an ether group; R⁶ is a hydrogen atom or an alkyl group of 1 to 6 carbon atoms; a is 0 to 10; and m is 0 to 420,

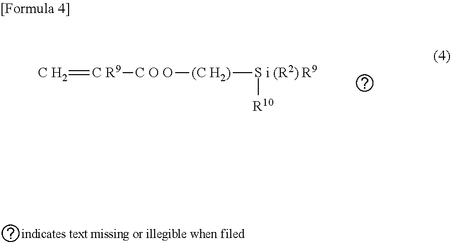

where: R⁷ is a hydrogen atom or a methyl group; R⁸, R⁹, and R¹⁰ are each independently a hydrogen atom, a methyl group, an ethyl group, a butyl group, or —OSi(CH₃)₃; R⁸, R⁹, and R¹⁰ may be the same or different from each other; and p is 0 to 10.

$$[ Formula 5 ]$$

$${R}^{11} - [ S \text{?} ( C \text{?} ) \text{?} - S i ( C \text{?} ) \text{?} - \text{?} \qquad ( 5 )$$

$$\text{?} \text{indicates text missing or illegible when filed}$$

where: R¹¹ is an alkyl group of 1 to 6 carbon atoms, —(CH₂)₁—OOC(CH₃)C═CH₂, —(CH₂)₁—OOC—HC═CH₂, or —CH═CH₂; R^{I2} is —(CH₂)ᵣ—OOC(CH₃)C═CH₂, —(CH₂)ᵣ—OOC—HC═CH₂, or —CH═CH₂; q is 1 to 420; and r is 1 to 6.

$$[ Formula 6 ]$$

$${R}^{12} - S i ( O S i ( C \text{?} ) \text{?} \qquad ( 6 )$$

$$\text{?} \text{indicates text missing or illegible when filed}$$

where R¹² is as defined above.

[2] The composition according to [1], where the fluorine-containing copolymer is formed from the polymerization units further containing one or more selected from alkyl vinyl ethers, alkyl allyl ethers, vinyl esters, methacrylic esters, and acrylic esters.

[3] The composition according to [1] or [2] comprising the amine compound in an amount of 0.005 to 10 parts by weight per 100 parts by weight of the fluorine-containing copolymer.

[4] The composition according to [3] comprising the solvent in an amount of 25 to 1900 parts by weight per 100 parts by weight of the fluorine-containing copolymer.

Further specifically, the composition according to [1] or [2] comprising, per 100 parts by weight of he fluorine-containing copolymer, 25 to 1900 parts by weight, preferably 43 to 900 parts by weight, and more preferably 67 to 400 parts by weight of the solvent; and 0005 to 10 parts by weight, preferably 0.05 to 10 parts by weight, and more preferably 0.05 to 5 parts by weight of the amine compound.

[5] A method of producing the composition according to any of [1] to [4] comprising (a) a step of copolymerizing the polymerization units by a solution polymerization method to fbrm a solution comprising a fluorine-containing copolymer.

[6] The method according to [5] further comprising (b) a step of adding an amine compound to the solution comprising a fluorine-containing copolymer obtained in step (a).

[7] The method according to [5] or [6], where the copolymerizing in step (a) is performed using, as a solvent, at least one selected from the group consisting of ethyl acetate, butyl acetate, xylene, toluene, and methyl ethyl ketone.

[8] A varnish or paint consisting of the composition according to any of [1] to [4],

[9] A method of using a varnish or paint consisting of the composition according to any of [1] to [4] in a coating method selected from the group consisting of a gravure coater, spin coater, dip coating, a roll coater, a reverse roll coater, a comma coater, a doctor blade coater, a bar coater a kiss roll coater, a curtain flow coater, roller coating, spray coating, electrospray coating, rotary screen printing, ink-jet coating, d brush coating.

[10] A coating film formed from the varnish or paint according to [9] by the coating method according to [9].

### ADVANTAGEOUS EFFECTS OF INVENTION

According to the present invention, a fluorine-containing copolymer composition that exhibits long-term stability and a fluororesin paint or varnish prepared using the composition are provided. According to the present invention, a method of producing the fluorine-containing copolymer composition is also provided. According to the present invention, further provided are: a t tethod of using the fluororesin paint or varnish in a coating method selected from the group consisting of a gravure coater, a spin coater, dip coating, a roll coater, a reverse roll coater, a comma coater, a doctor blade coater, a bar coater, a kiss roll coater, a curtain flow coater, roller coating, spray coating, electrospray coating, rotary screen printing, ink-jet coating, and brush coating; and a coating film formed from the above-mentioned varnish or paint by the above-mentioned coating method.

### DESCRIPTION OF EMBODIMENTS

[Action]

The present invention is characterized by the use of an amine compound as a. stabilizer in an amount within a particular range. It is generally known that when an amine compound is added to a reaction system containing an organosilicon compound, such as silicone oil, the reaction solution turns yellow. For this reason, amine compounds have not been used as a stabilizer for a paint or varnish containing an organosilicon compound. A fluorine-containing copolymer of the present invention, in which the polymerization units contain an organosilicon compound, is a high-molecular-weight organosilicon compound as well. Accordingly, there was a concern about problems, such as coloration, when an amine compound is used as a stabilizer. However, according to the studies by the present inventors, it was unexpectedly found possible to minimize the degree of coloration or the like by selecting the amount of amine compound to be added within a particular range and thereby to produce a fluorine-containing copolymer composition that has resolved problems, such as coloration, and that is excellent in long-term stability. Since problems, such as coloration, have been resolved, a fluorine-containing copolymer composition of the present invention is also useful as a paint or varnish.

[Fluorine-Containing Copolymer Composition]

A fluorine-containing copolymer composition of the present invention comprises: a fluorine-containing copolymer formed from polymerization units containing 5 to 85 mol % of a fluoroolefin and 0.001 to 50 mol % of one or more organosilicon compounds selected from the general formulae (1), (2), (3), (4), (5), and (6); a solvent; and an amine compound.

[Fluorine-Containing Copolymer]

A copolymer of a fluoroolefin and one or more organosilicon compounds selected from the general formulae (1), (2), (3), (4), (5), and (6) below is excellent in long-term water and oil repellency, removing properties of repeated stains, chemical resistance, and weatherability and hence is useful for various purposes. The present invention also provides a fluorine-containing copolymer characterized by being formed from polymerization units further containing, in addition to the above-mentioned polymerization units_{;} one or more selected from alkyl vinyl ethers, alkyl allyl ethers, vinyl esters, methacrylic esters, and acrylic esters. Herein, “—COO—” or “—OOC—” indicates an ester bond.

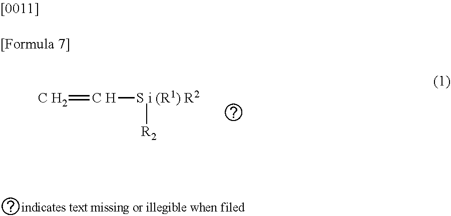

where: R¹, R², and R³ are each independently a hydrogen atom, a methyl group, an ethyl group, a butyl group, a phenyl group, —CF₃, —C₂H₄CF₃, —C(CH₃)₃, or —OSi(CH₃)₃; and R¹, R², and R.³ may be the same or different from each other.

$$[ Formula 8 ]$$

$$\text{?} = {C R}^{4} - {R}^{5} - \text{?} - {Si ( {CH}_{3} )}_{3} - ( O - Si ( \text{?} ) \text{?} ) \text{?} - {OSi ( {CH}_{3} )}_{2} {R}^{6} \qquad ( 2 )$$

$$\text{?} \text{indicates text missing or illegible when filed}$$

$$[ Formula 9 ]$$

$$C \text{?} = C \text{?} - COO - {( {CH}_{2} )}_{8} - Si ( \text{?} ) \text{?} - ( O - Si ( C \text{?} ) \text{?} ) - Osi ( C \text{?} ) \text{?} {R}^{6} \qquad ( 3 )$$

$$\text{?} \text{indicates text missing or illegible when filed}$$

where: R⁴ is a hydrogen atom or a methyl group; R⁵ is an ether group (i.e. —O—); R⁶ is a hydrogen atom or an alkyl group of 1 to 6 carbon atoms; n is 0 to 10; and m is 0 to 420, in particular, 0 to 160.

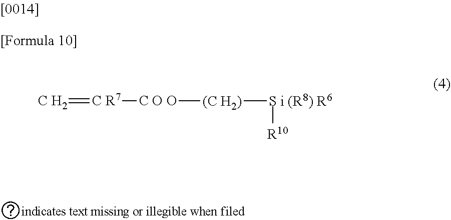

where: R⁷ is a hydrogen atom or a methyl group; R⁸, R⁹, and R¹⁰ are each independently a hydrogen atom, a methyl group, an ethyl group, a butyl group (for example, n-butyl group, isobutyl group, tort-butyl group, or sec-butyl group), or —OSi(CH₃)₃; R⁸, R⁹, and R¹⁰ may be the same or different from each other; and p is 0 to 10.

[Formula 11]

R¹¹—[Si(CH₃)₂—O]—SI(CH₃)₂—R¹² (5)

where: R¹¹ is an alkyl group of 1 to 6 carbon atoms, —(CH₂)ᵣ13 OOC(CH₃)C═CH₂, or —(CH₂)ᵣ—OOC—HC═CH₂, or —CH═CH₂; R¹² is —(CH₂)ᵣ—OOC(CH₃)C═CH₂, —(CH₂)ᵣ—OOC—HC═CH₂, or —CH═CH₂; q is 1 to 420; and r is 1 to 6.

[Formula 12]

R¹²—Si[OSi(CH₂)₂]₂ (6)

where R¹² is as defined above.

In the copolymer of the present invention, a fluoroolefin is an olefin having one or more fluorine atoms within the molecule, and preferable examples include vinylidene fluoride, tetrafluoroethylene, chlorotrifluoroethylene, and hexafluoropropylene. These fluoroolefins may be used alone or in combination of two or more.

Preferable concrete examples of the organosilicon compound represented by general formulae (1), (2), (3), (4), (5), and (6) include vinylpentamethyldsiloxane, vinylphenyldimethylsilane, vinylmethylbis(trimethylsiloxy)silane, vinyltriethylsilane, vinyl(tritfluoromethyl)dimethylsilane, vinyl(3,3,3-trifluoropropyl)dimethylsilane, vinyltrimethylsilane, vinyltris(trimethylsiloxy)silane, vinyl-tert-butyldimethylsilane, diethylmethylvinylsilane, (3-acryloxypropyl)methylbis(trimethylsiloxy)silane, (3-methacryloxypropyl)bis(trimethylsiloxy)methylsilane, (3-acryloxypropypl)tris(trimethylsiloxy)silane, (methaeryloxypropyl)tris(methylsiloxy)silane, methacryloxymethyltrimethylsilane, reactive silicone oil methacrylate-modified at either end, reactive silicone oil acrylate-modified at either end, reactive silicone oil methacrylate-modified at both ends, reactive silicone oil acrylate-modified at both ends, and organosilicon compounds represented by general formulae (7), (8), (9), and (10). These organosilicon compounds may be used alone or in combination of two or more. These organosilicon compounds preferably have a molecular weight of 100 to 30,000.

[Formula 13]

CH₂=C(CH₂)—COO—C₃H₆—Si(CH₃)₂—[O—SI(DH₃)₂]—R¹³ (7)

where: —C₃H₆— is a propylene group; R¹³ is an alkyl group of 1 to 6 carbon atoms; and a is 1 to 250.

[Formula 14]

CH₂═CH—COO—C₃H₆—Si(CH₂)₂—[O—Si(CH₃)₂]—R¹² (8)

where: —C₃H₆— is a propylene group; R¹³ is an. alkyl group of 1 to 6 carbon atoms; and a is 1 to 250.

[Formula 15]

R¹⁴C₃H₆—Si(CH₃)₂—[O—Si(CH₂)₂]₆—C₂H₆—R¹⁴ (9)

where: —R¹⁴ is —OOC(CH₃)C═CH₂; and b is 1 to 250.

[Formula 16]

$$[ Formula 16 ]$$

$${CH}_{2} = C ( C \text{?} ) COO - \text{?} - Si ( {OSi ( {CH}_{3} )}_{3} ) \text{?} \qquad ( 10 )$$

$$\text{?} \text{indicates text missing or illegible when filed}$$

where: —C₃H₆— is a propylene group.

Concrete examples of alkyl vinyl ethers include methyl vinyl ether, ethyl vinyl ether, isopropyl vinyl ether, n-propyl vinyl ether, n-butyl vinyl ether, isobutyl vinyl ether, n-pentyl vinyl ether, isopentyl vinyl ether, test-pentyl vinyl ether, n-hexyl vinyl ether, isohexyl vinyl ether, 2-ethylhexyl vinyl ether, n-heptyl vinyl ether, n-octyl vinyl ether, n-nonyl vinyl ether, n-decyl vinyl ether, n-undecyl vinyl ether, n-dodecyl vinyl ether, n-tridecyl vinyl ether, n-tetradecyl vinyl ether, n-pentadecyl vinyl ether, n-hexadecyl vinyl ether, n-heptadecyl vinyl ether, n-octadecyl vinyl ether, n-nonadecyl vinyl ether, n-icosyl vinyl ether, cyclohexyl vinyl ether, octadecyl vinyl ether, glycidyl vinyl ether, glycidyloxymethyl vinyl ether, glycidyloxyethyl vinyl ether, glycidyloxybutyl vinyl ether, glycidyloxypentyl vinyl ether, glycidyloxycyclohexyl vinyl ether, hydroxymethyl vinyl ether, hydroxyethyl vinyl ether, hydroxypropyl vinyl ether, hydroxybutyl vinyl ether, hydroxypentyl vinyl ether, hydroxyhexyl vinyl ether, hydroxyheptyl vinyl ether, hydroxyoctyl vinyl ether, hydroxynonyl vinyl ether, hydroxydecyl vinyl ether, hydroxyundecyl vinyl ether, hydroxydodecyl vinyl ether, hydroxytridecyl vinyl ether, hydroxytetradecyl vinyl ether, hydroxypentadecyl vinyl ether, hydroxyhexadecyl vinyl ether, hydroxyheptadecyl vinyl ether, hydroxyoctadecyl vinyl ether, hydroxynonadecyl vinyl ether, hydroxyicosyl vinyl ether, diethylene glycol monovinyl ether, triethylene glycol monovinyl ether, ethylene glycol monoallyl ether, cyclohexyl vinyl ether, and 4-hydroxycyclohexyl vinyl ether.

Concrete examples of alkyl allyl ethers include ethyl allyl ether, butyl allyl ether, cyclohexyl allyl ether, isobutyl allyl ether, n-propyl allyl ether, allyl glycidyl ether, 3-allyloxy-1,2-propanediol, glycerol α-monoallyl ether, and ethylene glycol monoallyl ether.

Concrete examples of acrylic esters include methyl acrylate, ethyl acrylate, n-butyl acrylate, tert-butyl acrylate, n-propyl acrylate, isopropyl acrylate, n-butyl actylate, isobutyl acrylate, n-pentyl acrylate, isopentyl acrylate, n-hexyl acrylate, 2-ethylhexyl acrylate, n-heptyl acrylate, n-octyl acrylate, n-nonyl acrylate, n-decyl acrylate, n-undecyl acrylate, n-dodecyl acrylate, 2-hydroxyethyl acrylate, 2-hydroxybutyl acrylate, and 2,2,2-trifluoroethyl acrylate.

Concrete examples of methacrylic esters include methyl methacrylate, ethyl methacrylate, n-butyl methacrylate, tort-butyl methacrylate, n-hexyl methacrylate, 2-ethylhexyl methacrylate, n-heptyl methacrylate, n-octyl methacrylate, n-nonyl methacrylate, n-decyl methacrylate, n-undecyl methacrylate, n-dodecyl methacrylate, n-tridecyl methacrylate, n-tetradecyl methacrylate, n-pentadecyl methacrylate, n-hexadecyl methacrylate, n-heptadecyl methacrylate, n-octadecyi methacrylate, n-nonadecyl methacrylate, n-icosyl methacrylate, glycidyl methacrylate, cyclohexyl methacrylate, 2-hydroxyethyl methacrylate, 2-hydrox:mropyl methacrylate, 3-hydroxypropyl methacrylate, 4-hydroxybutyl methacrylate, and 2,2,2-trifluoroethyl methacrylate.

Concrete examples of vinyl esters include carboxylic acid vinyl esters, such as vinyl acetate, vinyl n-butyrate, vinyl isobutyrate, vinyl propionate, vinyl caproate, vinyl caprylate, vinyl caprate, vinyl laurate, vinyl myristate, vinyl palmitate, and vinyl stearate.

A fluorine-containing copolymer of the present invention can form a coating film excellent in long-term water and oil repellency, removing properties of repeated stains, chemical resistance, and weatherability and may further contain, in addition to these units, other copolymerizable monomer units within a range not exceeding 20 mol % depending on intended uses and so forth.

Exemplary other copolymerizable monomers include: olefins, such as ethylene and propylene; haloolefins, such as vinyl chloride and vinylidene chloride; halogenated vinyl ethers, such as 2-(perfluorohexyl)ethyl vinyl ether; halogenated methacrylic esters, such as 2-(perfluorobutypethyl methacrylate and 2-(perfluorohexyl)ethvl methacrvlate; and halogenated acrylic esters, such as 2-(perfluorobutypethyl acrylate and 2-(perfluorohexyl)ethyl acrylate.

The fluorine-containing copolymer with less than 5 mol % of fluoroolefin polymerization units is not preferable since satisfactory soiling resistance cannot be attained when used as a paint base. Meanwhile, more than 85 mol % of the units is also not preferable since solubility in various solvents is low. Preferably, the proportion is 30 to 80 mol %. Further, less than 0.001 mol % in the proportion of an organosilicon compound selected from general formulae (1), (2), (3), (4), (5), and (6) is not preferable since satisfactory long-term water and oil repellency cannot be attained. Meanwhile, more than 50 mol % in the proportion is also not preferable since satisfactory chemical resistance and weatherability cannot be attained. The proportion of the organosilicon compound is preferably 0.005 to 30 mol %.

A fluorine-containing copolymer of the present invention can be produced through copolymerization of a mixture of monomers in predetermined proportions by a solution polymerization method using a polymerization initiator.

Exemplary polymerization initiators used for a solution polymerization method include: peroxyesters as a type of peroxides, such as test-butyl peroxyisobutyrate and tert-butyl peroxyacetate; dialkyl peroxydicarbonates, such as diisopropyl peroxydicarbonate and di-n-propyl peroxydicarbonate; benzoyl peroxide; and azobisisobutyronitrile. The amount of polymerization initiator to be used is selected appropriately depending on the types, copolymerization reaction conditions, and so forth but is typically selected within the range of 0.005 to 5 weight % and preferably 0.1 to 2 weight % relative to the total amount of polymerization units (monomers) to be used.

Examples of particularly preferable solvents for obtaining a fluorine-containing copolymer of the present invention by a solution polymerization method include ethyl acetate, butyl acetate, xylene, toluene, and methyl ethyl ketone.

The reaction temperature in the copolymerization reaction is commonly selected from the range of 0° C. to 100° C. and preferably 10° C. to 90° C. Moreover, the reaction pressure is not particularly limited but is commonly selected from the range of 0.1 to 10 MPa. and preferably 0.1 to 5 MPa. Further, the copolymerization reaction may be performed by adding a suitable chain transfer agent.

When a fluorine-containing copolymer of the present invention has hydroxy groups as curable parts, it is possible to cure at normal temperature by using polyisocyanates. Preferable examples of such polyisocyanates include yellowing-free diisocyanates, such as hexamethylene diisocyanate and isophorone diisocyanate, or adducts thereof; and polyisocyanates having isocyanurates. Among these, polyisocyanates having isocyanurates are particularly effective. When curing at normal temperature is performed using isocyanates, it is also possible to promote curing by addition of a publicly known catalyst, such as dibutyltin dilaurate.

Further, heat curing is also possible by using a melamine curing agent, a urea resin curing agent, a polybasic acid curing agent, and so forth. Exemplary melamine curing agents include butylated melamine, methylated melamine, and epoxy-modified melamine. Such curing agents having various degrees of modification are used appropriately depending on uses, and the degree of self-condensation may also be selected appropriately. Exemplary urea resin curing agents include methylated urea resin and butylated urea resin. Exemplary polybasic acid curing agents include long-chain aliphatic dicarboxylic acids, aromatic polycarboxylic acids, and acid anhydrides thereof.

Furthermore, blocked polyisocyanates can also suitably be used as curing agents. Meanwhile, when a melamine curing agent or a urea resin curing agent is used, it is also possible to promote curing by addition of an acidic catalyst.

Further, when a fluorine-containing copolymer of the present invention has epoxy groups as curable parts, curing agents commonly used for curable epoxy paints are used. Examples include: aliphatic amines, such as diethylenetriamine, triethylenetetramine, and tetraethylenepentamine, or modified compounds thereof; aromatic amines, such as m-phenylenediamine, p,p′-dia.minodiphenylmethane, and diaminodiphenylsulfone, or modified compounds thereof; and polycarhoxylic acids or anhydrides thereof, such as phthalic anhydride, maleic anhydride, anhydrous oxalic acid, hexahydrophthaiic acid, and pitnelic acid.

[Solvents]

Various solvents can be used for producing a fluororesin paint or varnish or a curable fluororesin paint or varnish containing, as a main component, a fluorine-containing copolymer of the present invention. Examples include aromatic hydrocarbons, such as xylene and toluene; acetate esters, such as ethyl acetate and butyl acetate; ketones, such as methyl ethyl ketone and methyl isobutyl ketone; glycol ethers, such as ethyl cellosolve; and various commercial thinners. Among these, ethyl acetate, butyl acetate, xylene, and toluene are particularly preferable. Moreover, it is possible to add, as necessary, an acrylic resin or an epoxy resin. Solvents are preferably used such that the content of a fluorine-containing copolymer in a paint is adjusted to 5 to 80 weight % and particularly to 20 to 60 weight %.

[Amine Compounds]

As a stabilizer in the present invention, an amine compound is used. Exemplary amine compounds include organic amines, such as primary amines, secondary amines, and tertiary amines: Such tertiary amines are preferably trialkylamines and particularly trialkylamines having lower alkyl groups of 1 to 4 carbon atoms. Such examples include trimethylamine, triethylamine, and tributylamine. Among amine compounds, triethylamine and tributylamine (especially, triisohutylamine) are particularly preferable for the reasons, such as the performance as a stabilizer, the degree of coloration, and easy availability.

[Method of Producing Fluorine-Containing Copolymer Composition]

For producing a fluorine-containing copolymer composition of the present invention, a fluorine-containing copolymer of the present invention and a solvent may be mixed using various devices commonly used for preparing paints, such as a ball mill, a paint shaker, a sand mill, a three-roll mill, and a kneader. On this occasion, an amine compound as an essential component of the composition of the present invention as well as optional components, such as an acrylic resin, a pigment, a dispersion stabilizer, a viscosity modifier, a leveling agent, and a UV absorber, may also be added as necessary. Since a fluorine-containing copolymer of the present invention is produced by a solution polymerization method, the reaction solution after polymerization contains a fluorine-containing copolymer and a solvent as main components. By adding a predetermined amount of amine compound to the reaction solution, a fluorine-containing copolymer composition of the present invention can be prepared.

The amount of amine compound to be added is preferably 0.005 to 10 weight %, more preferably 0,05 to 10 weight %, and further preferably 0.05 to 5 weight % relative to the total weight of a fluorine-containing copolytner of the present invention. In other words, the amount of amine compound to be added is preferably 0.005 to 10 parts by weight, more preferably 0.05 to 10 parts by weight, and further preferably 0.05 to 5 parts by weight per 100 parts by weight of the fluorine-containing copolymer. When the amount of amine compound is excessively small, long-term prevention of gelation tends to be difficult. Meanwhile, when the amount of amine compound is excessively large, the stabilizer tends to be wasted for attaining the same stabilization effect and the degree of coloration or the like is more likely to be significant.

[Uses of Fluorine-Containing Copolymer Composition]

A fluorine-containing copolymer composition of the present invention is excellent in long-term storage stability and does not substantially undergo any change in hue or any increase in viscosity even after storing for three months. For this reason, the composition is suitable for uses as paint or varnish. Specifically, a paint or varnish prepared from a fluorine-containing composition of the present invention is suitable for coating methods, such as a ;gravure coater, a spin coater, dip coating, a roll coater, a reverse roll coater, a comma coater, a doctor blade coater, a bar coater, a kiss roll coater, a curtain flow coater, roller coating, spray coating, electrospray coating, rotary screen printing, inkjet coating, and brush coating.

Painted articles can be used widely as in the following, for example. Exemplary exterior uses include automotive exterior paints and vehicle exterior films, such as automotive marking films, automotive window films, automotive paint protective films, and automotive exterior paint films. Concrete examples include automobile exteriors and exterior parts, such as automobile bodies, bumpers, spoilers, door knobs, headlamps, direction indicators, side minors, radiator grilles, and wheels. Other examples include motorcycle exteriors and exterior parts, such as motorcycle bodies, handlebars, saddles, and gas tanks. Further examples include train and other vehicle exteriors, exterior films, and exterior parts. Other examples include paints, protective films, marking films, glass surface coatings, and window films of vehicles, such as automobiles, motorcycles, and trains. Meanwhile, exemplary interior uses of vehicles, such as automobiles, include automotive interior sheets, steering wheels, meter panels, control panels, dashboards, door interiors, as well as paints, protective films, and design films for these uses.

Exemplary uses excluding those mentioned above include release films; electronic devices, such as cellphones, smartphones, PCs, TVs, portable terminals (including gaming consoles), and printers; home appliances, such as TVs, air conditioners, microwaves, refrigerators, washing machines, air cleaners, vacuum cleaners, and ventilating fans; toys; interior furnishings, such as racks, bookshelves, beds, desks, chairs, and sofas; ventilating fans; range hoods; kitchen panels; stainless steel sinks; bathtubs; and toilets as well as paints, protective films, and design films for these uses. Further examples include window films in buildings and so forth; glass surface coatings; outdoor marking films; protective films for various articles; and paints for construction materials.

### EXAMPLES

The present invention will now be described in further detail by means of working examples. However, the present invention is by no means limited by these examples.

### Example 1

To a stainless steel autoclave (pressure: 10 MPa) of 1 L in inner volume equipped with a stirrer after degassing, 4.7 g of vinylidene fluoride (hereinafter, abbreviated as VDF), 29.6 g of tetrafluoroethylene (hereinafter, abbreviated as TFE). 11.4 g of the organosilicon compound represented by the formula below, 42.7 g of hydroxybutyl vinyl ether (hereinafter, abbreviated as HBVE), 46.7 g of cyclohexyl vinyl ether (hereinafter, abbreviated as CHVE), 136.0 g of methyl methacrylate (hereinafter, abbreviated as MMA), 400 g of butyl acetate, 50 g of methyl ethyl ketone, and 5 g of tert-butyl peroxypivalate were fed and the internal temperature was elevated to 60° C. while stirring. Subsequently, the reaction was continued while stirring and terminated 20 hours later by stopping stirring. The reaction solution immediately after the polymerization reaction was a colorless transparent liquid in appearance.

CH₂═C(CH₃)—COO—(CH₂)₃—Si(CH₃)₂—[O—Si(CH₃)₂]₆₀—OSi(CH₃)₂—(CH₂)₃—CH₃ [Formula 17]

Gas chromatograph (GC) analysis of the reaction solution revealed the polymer yield (fluorine-containing copolymer yield) of 236 g and the monomer reaction rate of 87%. By adding 0.71 g of triisobutylamine to the resulting reaction solution containing the copolymer, butyl acetate, and methyl ethyl ketone, a fluorine-containing copolymer composition of the present invention was obtained. The separately isolated copolymer had a hydroxyl value of 88 mg KOH/g-resin measured by an acetylation method with acetic anhydride, a fluorine content by a combustion method of 8.0 wt. %, and a number average molecular weight measured by GPC of 2.0×10⁴. The characteristics of the resulting fluorine-containing copolymer composition were examined by the tbllowing methods. The results are shown in Table 1.

[Preparation of Coaling Film]

The resulting fluorine-containing copolymer composition was added with Corollate HX (from Nippon Polyurethane Industry Co., Ltd.) at a hydroxyl groups of the polymer (fluorine-containing copolyiner)/NCO groups of 1/1.1 and diluted with butyl acetate to have a solids concentration of 29%, thereby preparing a paint. The paint was applied to a glass sheet using a bar coater (#40), heat-treated at 80° C. for 24 hours to form a 25 μm-thick coating film, and evaluated.

[Storage Stability]

The Gardner color scale of the fluorine-containing copolymer composition after storing at 50° C. for 14 days was measured using OME 2000 colormeter fix petroleum products (from Nippon Denshoku Industries Co., Ltd.) and evaluated. As an accelerated test for storage stability, results after storing at 50° C. for 14 days are evaluated. This is because it is considered in the industry concerned that storage at 50° C. for 14 days corresponds to storage at normal temperature for six months.

[Yellowness Index (YI) of Coating Film]

The yellowness index (YI) of the coating film was measured by NR 555 handy spectrophotometric color difference meter (from Nippon Denshoku Industries Co., Ltd.).

[Haze]

The haze of the coating film was measured by HM-150L2 haze meter (from Murakami Color Research Laboratory Co., Ltd.).

### Examples 2 to 10, Comparative Examples 1 to 4

Each copolymer and copolymer composition were produced using the monomers shown in Table I in accordance with the procedure of Example 1, and the characteristics thereof were examined similarly. The results are shown in Table 1. Here, Comparative Examples 1 to 4 are comparative examples outside the scope of the present invention. In Table 1, the amount of amine compound is expressed as parts by weight relative to 100 parts by weight for a polymer yield (fluorine-containing copolymer yield) in the reaction solution.

TABLE 1

| | Example | | | | | | |
|---|---|---|---|---|---|---|---|
| Proportion g (mol %) | 1 | 2 | 3 | 4 | 5 | 6 | 7 |

| | | | | | | | | | | | |
|---|---|---|---|---|---|---|---|---|---|---|---|
| Essential | Fluoroolefin | VDF | 4.7 | (3) | 15.8 | (10) | 54.4 | (42.5) | 78.7 | (49.8) | 60.5 (38.3) |
| monomer | | TFE | 29.6 | (12) | 12.4 | (5) | 85.0 | (42.5) | 68.9 | (27.9) | 53.1 (21.5) |

| | | | | | | | | | |
|---|---|---|---|---|---|---|---|---|---|
| Organosilicon | n = 60 | 11.4 | (0.1) | — | 9.2 | (0.1) | 11.4 | (0.1) | 11.4 (0.1) |

| | | | | | | | |
|---|---|---|---|---|---|---|---|
| compound | n = 150 | — | 0.3 | (0.001) | — | — | — |

| | | | | | | | | |
|---|---|---|---|---|---|---|---|---|
| Other | Hydroxy group | DEGMVE | — | — | 39.4 | (14.9) | — | — |

| | | | | | | | | | | |
|---|---|---|---|---|---|---|---|---|---|---|
| monomer | (OH group)- | HBVE | 42.7 | (14.9) | 57.3 | (20) | — | 43 | (15) | 43.0 (15) |
| | containing | | | | | | | | | |

| | | | | | | | | |
|---|---|---|---|---|---|---|---|---|
| Hydroxy group | CHVE | 46.7 | (15) | — | — | 22.4 | (7.2) | 46.7 (15) |

| (OH group)- | n-BVE | — | | — | | — | — | 25.0 (10.1) |
|---|---|---|---|---|---|---|---|---|
| free | MMA | 136.0 | (55) | 160.7 | (65) | — | — | — |

| Polymer (fluorine-containing copolymer) yield (g) | | 236 | 190 | 168 | 179 | 147 | | |
|---|---|---|---|---|---|---|---|---|
| Stabilizer (amine compound) | Triethylamine | — | — | — | — | 0.005 | 0.05 | — |
| | (parts by weight) | | | | | | | |
| | Triisobutylamine | 0.3 | 0.3 | 0.3 | 0.3 | — | — | 0.3 |
| | (parts by weight) | | | | | | | |

| Polymer solution appearance | | colorless | colorless | slightly | colorless | colorless | | |
|---|---|---|---|---|---|---|---|---|
| (immediately after polymerization reaction) | | transparent | transparent | milky liquid | transparent | transparent | | |
| | | liquid | liquid | | liquid | liquid | | |
| Polymer OH value (mgKOH/g-resin) | | 88 | 146 | 99 | 117 | 141 | | |
| Number average molecular weight of polymer Mₙ (×10⁴) | | 2.0 | 1.8 | 2.0 | 2.2 | 3.0 | | |
| Storage | Gardner of polymer solution | 1 | 1 | 1 | 1 | 1 | | |
| stability | Yellowness index (YI) of coating film | 6.09 | 5.91 | 7.98 | 6.15 | 6.36 | | |
| (before test) | Haze | 0.3 | 0.6 | 55.0 | 0.9 | 0.4 | | |
| Storage | Gardner of polymer solution | 2 | 1 | 1 | 1 | 1 | 1 | 1 |
| stability | Yellowness index (YI) of coating film | 6.25 | 5.99 | 8.32 | 6.13 | 6.04 | 6.2 | 5.79 |
| (50° C., 14 | Haze | 0.2 | 0.5 | 41.9 | 0.5 | 0.4 | 0.5 | 0.5 |
| days later) | | | | | | | | |

| | Example | | | Comparative Example | | | |
|---|---|---|---|---|---|---|---|
| Proportion g (mol %) | 8 | 9 | 10 | 1 | 2 | 3 | 4 |

| Essential | Fluoroolefin | VDF | 60.5 (38.3) | — | | 71.1 | (45) | 78.7 | (49.8) | 60.5 | (38.3) |
|---|---|---|---|---|---|---|---|---|---|---|---|
| monomer | | TFE | 53.1 (21.5) | 9.9 | (4) | 111.2 | (45) | 68.9 | (27.9) | 53.1 | (21.5) |

| | | | | | | | | | |
|---|---|---|---|---|---|---|---|---|---|
| Organosilicon | n = 60 | 11.4 (0.1) | — | 11.4 | (0.1) | 11.4 | (0.1) | 11.4 | (0.1) |

| | | | | | | | | |
|---|---|---|---|---|---|---|---|---|
| | compound | n = 150 | — | 0.3 | (0.001) | — | — | — |
| Other | Hydroxy group | DEGMVE | — | 84.9 | (26) | — | — | — |

| | | | | | | | | | | |
|---|---|---|---|---|---|---|---|---|---|---|
| monomer | (OH group)- | HBVE | 43.0 (15) | — | 28.4 | (9.9) | 43 | (15) | 43.0 | (15) |
| | containing | | | | | | | | | |

| | | | | | | | | | |
|---|---|---|---|---|---|---|---|---|---|
| Hydroxy group | CHVE | 46.7 (15) | 108.9 | (35) | — | 22.4 | (7.2) | 46.7 | (15) |

| | | | | | | | | |
|---|---|---|---|---|---|---|---|---|
| (OH group)- | n-BVE | 25.0 (10.1) | 86.6 | (35) | — | — | 25.0 | (10.1) |

| | | | | | | |
|---|---|---|---|---|---|---|
| free | MMA | — | — | — | — | — |

| Polymer (fluorine-containing copolymer) yield (g) | | 147 | | | — | 209 | — | 147 |
|---|---|---|---|---|---|---|---|---|
| Stabilizer (amine compound) | Triethylamine | — | — | — | — | — | — | — |
| | (parts by weight) | | | | | | | |
| | Triisobutylamine | 5 | 7 | 10 | — | — | 0 | 0 |
| | (parts by weight) | | | | | | | |

| Polymer solution appearance | | colorless | | | polymerization | milky | colorless | colorless |
|---|---|---|---|---|---|---|---|---|
| (immediately after polymerization reaction) | | transparent | | | reaction did not | highly viscous | transparent | transparent |
| | | liquid | | | proceed | liquid (impossible | liquid | liquid |
| | | | | | | to use) | | |
| Polymer OH value (mgKOH/g-resin) | | 141 | | | 382 | 66 | 117 | 141 |
| Number average molecular weight of polymer Mₙ (×10⁴) | | 3.0 | | | 0.2 | 4.9 | 2.2 | 3.0 |
| Storage | Gardner of polymer solution | 1 | | | — | — | 1 | 1 |
| stability | Yellowness index (YI) of coating film | 6.36 | | | — | — | 6.15 | 6.36 |
| (before test) | Haze | 0.4 | | | — | — | 1.0 | 2.2 |
| Storage | Gardner of polymer solution | 2 | 3 | 3 | — | — | gelation | gelation |
| stability | | | | | | | (7th day) | (5th day) |
| (50° C., 14 | Yellowness index (YI) of coating film | 6.28 | 6.33 | 6.22 | — | — | — | — |
| days later) | Haze | 0.3 | 0.3 | 0.3 | — | — | — | — |

(1) Fluoroolefins

VDF: vinylidene fluoride

TFE: tetrafluoroethylene

(2) Structural formulae of organosilicon compounds:

n=60:

CH₂═C(CH₃)—C(H)—(CH₂)₃—Si(CH₃)₂—[O—Si(CH₃)₂]—OSi(CH₃)₂—(CH₂)₃—CH₃ [Formula 18]

n≤150:

CH₂═C(C₃)—COO—(CH₂)₃—Si(CH₃)₂—[O—Si(CH₃)₂]—OSi(CH₃)₂—(CH₂)₃—CH₂ [Formula 19]

(3) Hydroxy group (OH group)-containing

DEGMVE: diethylene glycol monovinyl ether

HBVE: hydroxybutyl vinyl ether

(4) Hydroxy group (OH group)-free

CHVE: cyclohexyl vinyl ether

n-BVE: n-butyl vinyl ether

MMA: methyl methacrylate

It was found that each fluorine-containing copolymer composition of the present invention, which contains an amine compound within a range of 0.005 parts by weight to 10 parts by weight per 100 parts by weight of a fluorine-containing copolymer, exhibits even after storing at 50° C. for 14 days a low Gardner color scale of 1 to 3, a yellowness index (YI) of the coating film of 8.32 or less, a haze of 41.9 or less, and little color change or the like. Meanwhile, the monomer mixture of Comparative Example 1, which used 4 mol % of a fluoroolefin, did not undergo polymerization reactions, and hence, a fluorine-containing copolymer was not obtained. The fluorine-containing copolymer composition of Comparative Example 2, which used 90 mol % of fluoroolefins, was a milky highly viscous liquid and hence was not evaluated later. Comparative Examples 3 and 4, which did not contain any amine compound, underwent gelation on the seventh day and the fifth day from the start of the storage, respectively. From the test results in Table 1, it was found possible, by selecting the amount of amine compound to be added within a particular range, to minimize the degree of coloration or the like and to produce a fluorine-containing copolymer composition that has resolved the problems, such as coloration, and that is excellent in long-term stability. Since the problems, such as coloration, have been resolved, a fluorine-containing copolymer composition of the present invention is also useful as paint or varnish.

1. A composition comprising:
a fluorine-containing copolymer formed from polymerization units containing 5 to 85 mol % of a fluoroolefin and 0.001 to 50 mol % of one or more organosilicon compounds selected from general formulae (1), (2), (3), (4), (5), and (6);
a solvent; and
an amine compound. 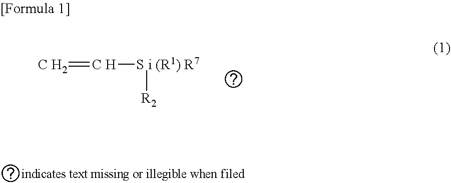
wherein: R¹, R², and R³ are each independently a hydrogen atom, a methyl group, an ethyl group, a butyl group, a phenyl group, —CF₃, —C₂H₄CF₃, —C(CH₃)₃, or —OSi(CH₃)₃; and R¹, R², and R³ may be the same or different from each other.
$$[ Formula 2 ]$$
$$C \text{?} = C \text{?} - \text{?} - \text{?} - S i \text{?} - ( O - S i \text{?} - O S i \text{?} \qquad ( 2 )$$
$$\text{?} \text{indicates text missing or illegible when filed}$$
$$[ Formula 3 ]$$
$$C \text{?} = C \text{?} - COO - \text{?} - S i \text{?} - ( O - S i \text{?} - O S i \text{?} \qquad ( 3 )$$
$$\text{?} \text{indicates text missing or illegible when filed}$$
wherein: R⁴ is a hydrogen atom or a methyl group; R⁵ is an ether group; R⁶ is a hydrogen atom or an alkyl group of 1 to 6 carbon atoms; n is 0 to 10; and m is 0 to 420. 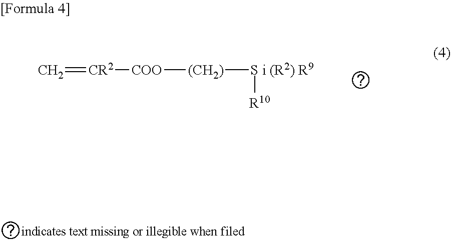
wherein: R⁷ is a hydrogen atom or a methyl group; R⁸, R⁹, and R¹⁰ are each independently a hydrogen atom, a methyl group, an ethyl group, a butyl group, or —OSi(CH₃)₃; R⁸, R⁹, and R¹⁰ may be the same or different from each other; and p is 0 to 10.
[Formula 5]
R¹¹—[Si(CH₂)₂—O]₄—Si(CH₃)₂—R¹ (5)
wherein: R¹¹ is an alkyl group of 1 to 6 carbon atoms, —(CH₂)ᵣ—OOC(CH₃)C═CH₂, —(CH₂)ᵣ—OOC—HC═CH₂, or —-CH═CH₂; R¹² is —(CH₂)ᵣ—OOC(CH₃)C═CH₂, —-(CH₂)ᵣ—OOC—HC═CH₂, or —CH═CH₂; q is 1 to 420; and r is 1 to 6.
[Formula 6]
R¹²—Si[OSi(CH₃)]₃ (6)
wherein R¹² is as defined above.

2. The composition according to claim 1, wherein the fluorine-containing copolymer is formed from the polymerization units further containing one or more selected from alkyl vinyl ethers, alkyl allyl ethers, vinyl esters, methacrylic esters, and acrylic esters.

3. The composition according to claim 1 comprising the amine compound in an amount of 0.005 to 10 parts by weight per 100 parts by weight of the fluorine-containing copolymer.

4. The composition according to claim 3 comprising the solvent in an amount of 25 to 1900 parts by weight per 100 parts by weight of the fluorine-containing copolymer.

5. A method of producing the composition according to claim 1 comprising (a) a step of copolymerizing the polymerization units by a solution polymerization method to form a solution comprising a fluorine-containing copolymer.

6. The method according to claim 5 further comprising (b) a step of adding an amine compound to the solution comprising a fluorine-containing copolymer obtained in step (a).

7. The method according to claim 5, wherein the copolymerizing in step (a) is performed using, as a solvent, at least one selected from the group consisting of ethyl acetate, butyl acetate, xylene, toluene, and methyl ethyl ketone.

8. A varnish or paint consisting of the composition according to claim 1.

9. A method of using a varnish or paint consisting of the composition according to claim 1 in a coating method selected from the group consisting of a gravure coater, a spin coater, dip coating, a roll coater, a reverse roll coater, a comma coater, a doctor blade coater, a bar coater, a kiss roll coater, a curtain flow coater, roller coating, spray coating, electrospray coating, rotary screen printing, ink-jet coating, and brush coating.

10. A coating film formed from the varnish or paint used in the coating method according to claim 9.
